(19) United States
(12) Patent Application Publication
(10) Pub. No.: US 2011/0280674 A1
(43) Pub. Date: Nov. 17, 2011

(54) MACHINING DEVICE FOR PRODUCING A DRILLING JIG FOR DENTAL IMPLANTS

(76) Inventors: Ady Palti, Baden-Baden (DE); Herbert Hatzlhoffer, Waldbronn (DE)

(21) Appl. No.: 13/055,935

(22) PCT Filed: May 9, 2008
(86) PCT No.: PCT/EP2008/003736

§ 371 Date: Jul. 11, 2011

(51) Int. Cl. A61C 13/34; A61C 13/38; A61C 8/00

(52) U.S. Cl. 408/1 R; 408/237; 408/3

(57) ABSTRACT

The invention relates to a machining device, especially for producing a drilling jig for dental implants. The tool can be displaced along three translational axes and can be swiveled about two swiveling axes. The displacement device for the tool comprises a C frame which can be displaced along two horizontal translational axes.

The invention relates to a machining apparatus for dental technicians and dentists, in particular for producing a drilling template for dental implants. Dental implants are foreign bodies inserted into the jaw bone. The branch of dentistry which deals with the planting of dental implants in the jaw bone is designated as implantlogy. Due to the usefulness thereof as a support for a dental prosthesis, dental implants perform the function of artificial dental roots. A drilling template, which is produced by a machining apparatus, is required for placing the dental implants in the jaw.

A machining apparatus comprises a chassis, a work table for mounting the drilling template and/or a jaw model (e.g. made of piaster or plastic) and a retainer for a drilling tool which is linearly displaceable relative to the work table in the longitudinal direction of the drill, wherein devices for adjusting the inclination of the drill axis relative to the work table about two rotation axes perpendicular to one another are arranged between the work table and the chassis or between the retainer for a drilling tool and the chassis.

The technique of replacing a lost tooth by a dental implant and a dental prosthesis or triage fastened thereto has gained acceptance in the meantime. Used in this case is an implant, the implant root, which is produced from a ceramic mass or metal and is anchored in the bone and on which the artificial dental crown is fastened. To this end, a hole for the implant root has to be made in the jaw at the location of the lost tooth. Since the artificial dental crowns fit harmoniously into the row of teeth, the implant root is to have as large a diameter as possible for the better absorption of masticatory pressure and there is limited bone available in the jaw, the position and angular orientation of the hole must be exactly calculated beforehand and maintained.

In order to ensure this, first of ail a drilling template is normally produced, said drilling template having, at the predetermined location, a drilling sleeve which is adjusted with respect to the angular position and the inside diameter of which corresponds to the diameter of a pilot drill for the jaw hole. The drilling template is worn by the patient during the drilling of the pilot hole. This drilling template can be produced with the aid of a jaw model of the patient or purely from data obtained radiographically or by computed tomography. Furthermore, the information concerning the extent of the jaw bone, this information being necessary for establishing the drilling direction is obtained by means of computed tomography, various sectional illustrations through the jaw being possible. Other methods which are used for measuring the jaw for producing a drilling template are, for example, bone mapping, bone measurement using a probe, or other measuring methods.

The drilling sleeves are often attached in the drilling template by freehand after evaluations of the radiograph and the jaw model, in which case inaccuracies which would have to be corrected by widening the pilot hole in the jaw have to be avoided.

Before the placement of dental implants, first of ail the positions which the implants are to assume in the jaw bone have to be established. To this end, an impression of the region of the mouth cavity is made, said impression containing the toothless locations and possibly teeth or rows of teeth adjacent thereto. A model is then produced from this impression, said model corresponding to the region of the mouth cavity into which the implants are to he inserted. The positions of the implants are then established on this model. In a next step, a template for the model is produced. Positioning aids which serve to guide the surgical tools during the machining of the bone are inserted into this template at the implant locations. As a rule, the positioning aids are sleeves. The sleeves are mostly fastened in the template by casting in place, imbedding into a polymer or screwing in place.

However, it is also possible to measure the jaw bone with an inserted template and to transmit the data obtained in the process directly with a machining apparatus to a drilling template without having to produce a jaw model beforehand.

Drilling templates are therefore auxiliary devices for making it easier for the implantologist to make a hole in the jaw bone of a patient, into which hole the implant is to be inserted. The drilling template has a drill hole which is produced on the jaw model and which serves as a guide for the drill when making the hole in the jaw bone. The drill hole is to have the correct position and angular position. Such a drilling template is disclosed, for example, by EP 1 321 107 A1.

The invention relates to a machining apparatus for dental technicians and dentists which serves in particular for producing such a drilling template for dental implants.

Various machining apparatuses for producing drilling templates are known in the prior art. A machining apparatus according to the preamble of patent claim 1 is known from EP 1 709 329 A1. It comprises
a fixed, stationary chassis having a fixed, stationary base plate which at least indirectly carries a work fable for accommodating a workpiece,
a tool holder movably arranged relative to the base plate for a tool, such as, in particular, a drill, having an approximately vertical tool axis W, wherein the tool holder is adjustably pivotable relative to the base plate about a first horizontal pivot axis A and a second horizontal pivot axis B, wherein the pivot axes A, B lie in a common horizontal plane and form an angle of about 90° to one another,
and a traversing device for traversing the tool holder relative to the work table, wherein the traversing device is linked to the chassis or the base plate, carries the tool folder and has two translational axes X, Y, along which the tool holder can be adjustably traversed by means of the traversing device,
wherein the first translational axis X and the second translational axis Y are oriented in a horizontal direction, and the first translational axis X and the second translational axis Y lie in a common horizontal plane and form an angle of about 90° to one another, and
the tool holder can be traversed along a third translational axis Z, which is identical to the tool axis W, relative to the work table.

Even though good results could be achieved with this machining apparatus, it has been proved in practice that both the mechanical rigidity for achieving high machining precision and the mechanical construction for achieving optimized operability and the ergonomics for the user can be improved.

An apparatus and a system for producing a drilling template for dental implants are described in DE 197 09 215 A1, said apparatus having a fixed frame on which a work table having a jaw model with drilling template is arranged so as to be rotatable about a vertical axis and displaceable in a horizontal plane in two directions perpendicular to one another. To set the horizontal position of the workplace, it is positioned with the work table in two horizontal translational directions by traversing the work table. The frame carries a tool holder which is pivotable relative to the frame about two horizontal axes in order to be able to position the drill, to be arranged in the tool holder, in various angular positions relative to the drilling template. As a result, the apparatus has five adjustable degrees of freedom in order to be able to apply the drill to various positions of the drilling template at various angles.

A machining apparatus having at least four pivot axes is known from EP 1 520 551 A2.

Known from U.S. Pat. No. 6,634,883 B2 is a machining apparatus in which an extension arm ha a two horizontal pivot axes. However, the horizontal translational axes are assigned to the model-holding plate, and the model-holding plate or the workpiece/model (without separate pivoting means) arranged on it must be adjusted in the X or Y direction. This complicates the work with the machining apparatus, for the pivoting about the pivot axes must be effected at the tool holder, whereas the horizontal adjustment or correction must be effected at the model-holding plate supported on the base plate.

Consequently, in this prior art, there is no fixed reference point of the workpiece from which the tool holder can be set. On the contrary, all the adjustable components, which influence each other, must virtually be set at the same time until the desired working position has been reached. In addition, in this prior art, the two horizontal pivot axes also do not form a common intersecting point with the tool axis arranged eccentrically relative to one of the two pivot axes, which leads to disadvantages.

DE 101 32 98 6 A1 describes an apparatus for dental preparations guided in a duplicated manner. FR 2 687 937 A1 and WO 1995/00079 A1 relate to the general prior art of positioning devices.

Proceeding therefrom, the object of the present invention is to provide a machining apparatus which improves even further the work with the model arranged thereon and in particular also enables drill holes to be made in the drilling template in exactly the right position. Proceeding from a known machining apparatus, the object of the present invention is therefore to improve a machining apparatus of the type mentioned at the beginning with regard both to its accuracy and to its ergonomics and automation in respect of the work and adjustment options.

The object is achieved according to the invention by a machining apparatus having the features of patent claim 1. Preferred configurations follow from the dependent patent claims and the description below with associated drawings.

A machining apparatus according to the invention for dental technicians and dentists, in particular for producing a drilling template for dental implants, therefore comprises
a fixed, stationary chassis having a fixed, stationary base plate which at least indirectly carries a work table for accommodating a workpiece,
a tool holder movably arranged relative to the base plate for a tool, such as, in particular, a drill, having an approximately vertical tool axis W, wherein the tool holder is adjustably pivotable relative to the base plate about a first horizontal pivot axis A and a second horizontal pivot axis B, wherein the pivot axes A, B lie in a common horizontal plane and form an angle of about 90° to one another,
and a traversing device for traversing the tool holder relative to the work table, wherein the traversing device is linked to the chassis or the base plate, carries the tool holder and has two translational axes X, Y, along which the tool holder can be adjustably traversed by means of the traversing device,
wherein the first translational axis X and the second translational axis Y are oriented in a horizontal direction, and the first translational axis X and the second translational axis Y lie in a common horizontal plane and form an angle of about 90° to one another, and
the tool holder can be traversed along a third translational axis Z, which is identical to the tool axis W, relative to the work table,
   and has the special features that
the traversing device is designed as a traversable, inherently rigid supporting C-frame which comprises a top horizontal C-frame part, a central vertical C-frame part and a bottom horizontal C-frame part,
the first horizontal translational axis X is oriented transversely to the supporting C-frame and parallel to the second horizontal pivot axis B,
the second horizontal translational axis Y is oriented in the direction of the top C-frame part and bottom C-frame part and parallel to the first horizontal pivot axis A,
the bottom C-frame part can be adjustably traversed along the first horizontal translational axis X relative to the base plate, and
the bottom C-frame part can be adjustably traversed along the second horizontal translational axis Y relative to the base plate.

It has been found that optimum work and production of a drilling template is possible with such a machining apparatus because the tool holder can be brought into any desired position both relative to the workpiece and relative to the user in a specific and simple manner. At the same time, ergonomically optimal work is possible, it being possible for the user to remain at a fixed workplace, to which the fixed bottom base plate and the work table located thereon in a fixed position are assigned, and so the user can assume a fixed position relative to the work table. Nonetheless, the position of the tool holder with respect to the workpiece or the user can in this case be varied in any desired manner by means of suitable operating elements and the construction has high rigidity, with which nigh production accuracy is achieved.

In connection with the present invention, tins specification of a pivot or translational axis relates as a rule to that direction of movement which the corresponding part, i.e. the tool holder or the supporting C-frame or its top or bottom C-frame part follows during the movement, for example with respect to the centre axis of the moved part.

According to a further advantageous feature, provision can be made for at least two, preferably all three axes of the two horizontal pivot sixes A, B and the tool axis W to intersect at a common, intersecting point O. The intersecting at a common intersecting point P results in the advantage that pivoting of the tool about one of the two pivot axes A, B primarily leads only to a change in the pivot angle, thus to a change in the orientation of the tool, but without pivoting the fool and in particular the machining region of the tool, that is to say, for example, the drill point, too far out of the zero position over lengths of travel. This is because, in an eccentric arrangement of the tool axis W relative to one or both pivot axes A, B, pivoting leads to a considerable change in position of the machining region of the tool over lengths of travel, which makes the setting of the working position and the work with such a tool unnecessarily difficult on account of the readjustments required in the process, in particular in respect of the translational axes.

According to a further advantageous feature, provision can be made for the second horizontal translational axis Y to intersect the third translational axis Z at an intersecting point S, in particular with respect to a vertical alignment of the third translational axis. In this case, provision can be made in a further advantageous configuration for the intersecting point S not to coincide with the common intersecting point O, for the intersect rug point S to lie below the common, intersecting point O, for the intersecting point S to lie below the workpiece, for the intersecting point S to lie below the horizontal plane in which the first horizontal translational axis X runs and/or for the intersecting point S to lie within the base plate.

The top C-frame part preferably serves as an extension arm for the tool holder, i.e. the tool holder is attached to the top C-frame part in a position which is stationary relative to the top C-frame part. The tool holder can be adjusted along the three translational axes X, Y and Z relative to the base plate or the tool table in order to thereby be able to approach all the requisite working positions of the machining apparatus or of the workpiece, positioned thereon, by means of the tool holder or the tool.

The user, in particular if he receives the predetermined set points for ail the adjustable coordinates from a computer, can therefore quickly bring the tool into position in a simple manner in order to then be able to carry out the machining operation.

Finally, provision can be made for the work table or a work holder of the work table for the workpiece to be designed in such a way that the workpiece can be pivoted about a vertical pivot axis C extending perpendicularly to the base plate in order thus to also be able to pivot the workpiece by up to 360° about the C axis relative to the tool holder or relative to the tool. The rotation about the C axis can serve to bring the workpiece into another position in order to be able to nonetheless drill large angles if the deflection of the A and B axes is restricted in terms of equipment. This pivot axis C running through the workpiece forms a fixed reference point. If the X axis and the Y axis or A axis are set in such a way that the A axis and the B axis pass through the C axis and the W or Z axis coincides with the C axis, the “absolute zero point” of the machining apparatus system is obtained, such that all coordinates of the tool holder, that is to say actual values and set points, can relate to these zero settings during the machining of a workpiece and are thus also reproducible. The adjustability of the workpiece in the vertical pivot axis C therefore serves to set a zero position of the workpiece. On the other hand, during the machining of the workpiece using the machining apparatus, the position set in the C axis is as a rule maintained and is not changed any further.

It is especially advantageous if the second translational axis Y runs parallel to the first pivot axis A. As a result, the three-dimensional movement of the tool relative to the base plate or relative to the work table can be split into simple Cartesian coordinates, because, during pivoting about the second pivot axis B, the vertical tool axis moves in the Y direction and thereby compensates for or amplifies translational adjustments in the Y direction.

Provision can advantageously be made for the bottom C-frame part to be linked to an X-Y-coupling support, relative to which the bottom C-frame part can be adjustably displaced along the second horizontal translational axis Y, wherein the X-Y-coupling support can be adjustably displaced along the first horizontal translational axis X. This makes possible defined and readily controllable positioning.

Said pivot and translational axes are expediently combined with looking means in order to be able to maintain a pivot or translational position, set once, during the entire operating process. Only the first translational axis Z, which corresponds to the tool axis W, has to be movable in the direction of the tool axis for the machining operation, that is to say in particular for the drilling of a drill hole in the drilling template, at least movable until a predetermined stop is reached.

The locking means expediently consist of tapered clamps in order to permit reliable and undistorted fixing via surface pressures over a large tapered area and not only via point pressures.

In order to be able to better set and monitor the position of various axes, it is furthermore advisable to digitize the axes, that is to arrange motion or position transducers thereon. As a result, the coordinates which can be set and which are to be set and which can be predetermined, for example, by diagnostic software as a set point for the position and orientation of the respective drill hole in the drilling template can be taken into account during the adjustment of the various axes by appropriate indicating means, which indicate the respective actual value, until finally all the actual values correspond to the predetermined set points. In this connection, it is advisable if the data determined by the diagnostic software are present in ASCII format and can be transferred to a set point table and thus compared with the actual values, likewise present in ASCII format.

Accordingly, the pivot exes A, B and/or translational axes X, Y, Z advantageously have scanning means, by means of which digitized actual position data concerning the pivot and/or translational position can be produced.

The adjustment of the various axes and therefore the change in the actual values for achieving the set points can firstly be effected manually; however, it is likewise also possible for motor-operated actuating devices, e.g. servomotors or linear drives, to be provided on the axes, said actuating devices carrying out the adjustment movements in the pivot or translational direction. In this case, automated setting of the drilling position right through to automated drilling is possible.

Accordingly, the machining apparatus can advantageously have one or more of the following motor-operated actuating drives: for adjustably pivoting the tool holder about the first pivot axis A and the second pivot axis B, for adjustably traversing the supporting C-frame along the first horizontal translational axis X and the second horizontal translational axis Y, for adjustably traversing the tool along the tool axis W and/or for adjustably traversing the tool holder along the third translational axis Z. The motor-operated actuating drives can be designed such that they can be activated, for automated machining operations, for automatically setting defined positions with the aid of digital desired positioning data.

During both manual adjustment and mechanical adjustment, the user can receive a release signal (for example optical or acoustic) when the predetermined set points are reached, whereupon he can start the machining operation and set the drill hole. If the tool has also reached its set point along the Z axis during the machining operation, the user can be informed about this by a further optical or acoustic indication and can stop the machining.

Especially advantageous with the digitizing of the data is the fact that these actual values can be logged in what is known as a black box in order to thereby be able to reproducibly retrieve these actual values in an uncomplicated and tamper-proof manner, even weeks or months after the machining operation, as a result of which the user can accordingly verify the actual values used by him during the machining.

The digitizing of the setting data in combination with motor-operated actuating devices permits automated setting of the drilling position right through to automated drilling of one or more holes.

The invention is explained in more detail below with reference to an exemplary embodiment shown in the figures. The special features described therein can be used individually or in combination with one another in order to provide preferred embodiments of the invention. In the drawing:

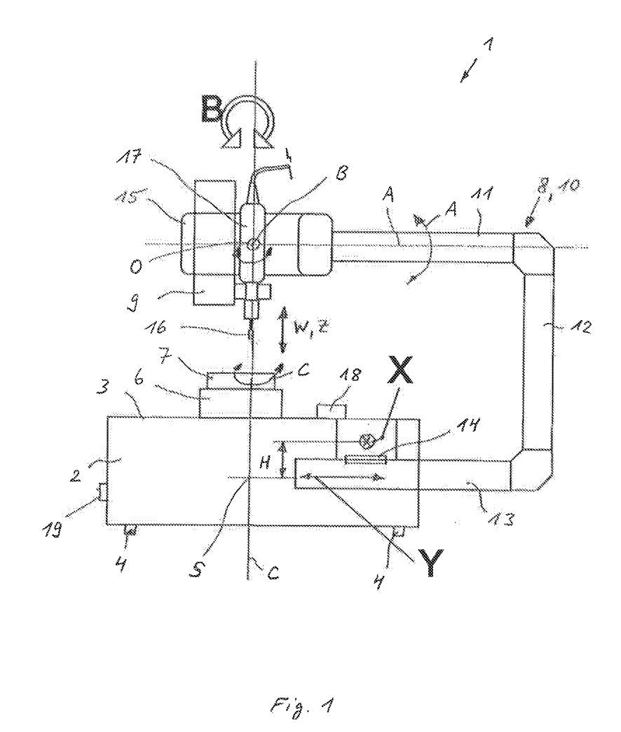

FIG. 1 shows a diagrammatic sketch of a machining apparatus according to the invention in side view,

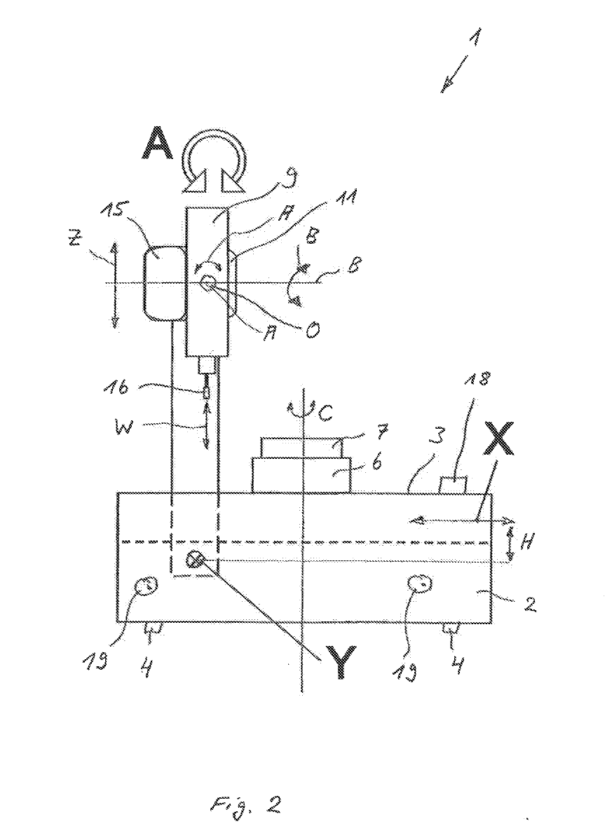

FIG. 2 shows a diagrammatic sketch of the machining apparatus from FIG. 1 in front view,

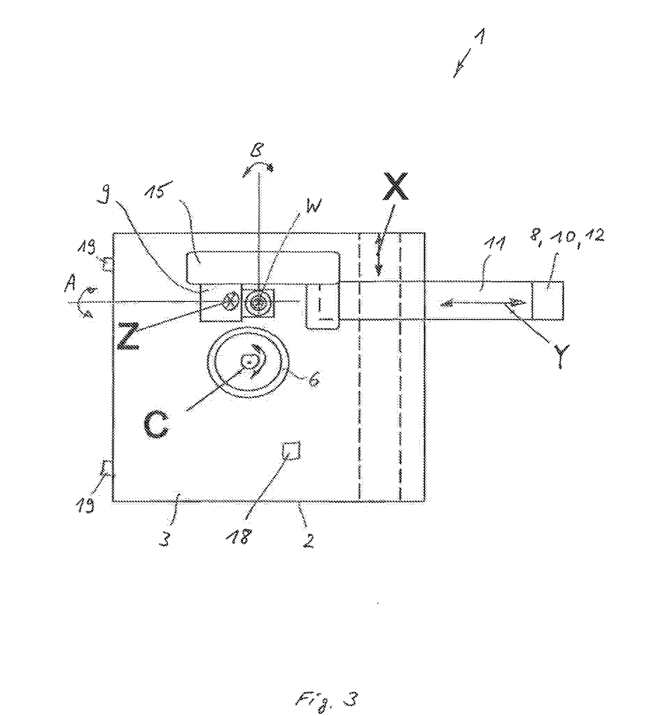

FIG. 3 shows a diagrammatic sketch of the machining apparatus from FIG. 1 in plan view, and

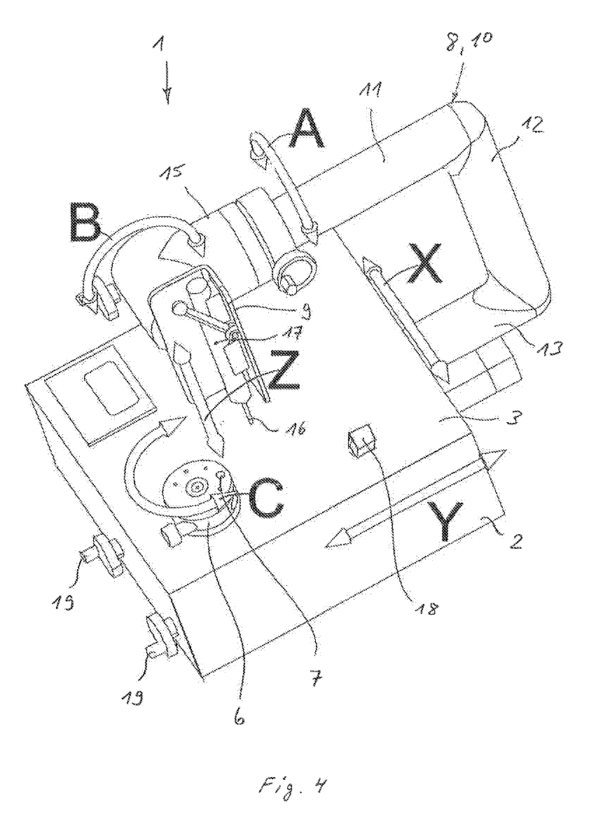

FIG. 4 shows a perspective diagrammatic view of the machining apparatus from FIG. 1.

Shown in FIGS. 1 to 4 is a machining apparatus 1 which has a chassis 2 having a horizontal bottom base plate 3 which can be fixedly set up on a base (not shown), such as, for instance, a laboratory bench top, etc., via feet 4, 5 or can be attached to the base. The base plate 3 carries a work table 6 having a model-holding plate, on which a workpiece or model (not shown), for example a jaw model, can be fixed, wherein the position of the model-holding plate relative to the base plate 3 on the other hand can be adjusted in its inclination via additional actuators 7, the “articulators”, and in virtually any desired manner via the pivotable mounting about a vertical pivot axis C extending perpendicularly to the base plate 3. The chassis 2 and the base plate 3 are stationary and fixed relative to the base.

A traversing device 8 for traversing a tool holder 9 is linked to the chassis 2 or the base plate 3. The traversing device 8 is designed as a traversable, inherently rigid supporting C-frame 10 which comprises a top horizontal C-frame part 11, a central vertical C-frame part 12 and a bottom horizontal C-frame part 13, carries the tool holder 9 and has two translational axes X, Y, along which the tool holder 9 can be adjustably traversed by means of the traversing device 8. The first translational axis X and the second translational axis Y are in this case oriented in horizontal direction and lie in a common horizontal plane, wherein they form an angle of approximately 90°.

The first horizontal translational axis X is oriented transversely to the supporting C-frame 10 and the second horizontal translational axis Y is oriented in the direction of the top and bottom C-frame parts 11, 13. The bottom C-frame part 13 can therefore be adjustably traversed along the first horizontal translational axis X and along the second horizontal translational axis Y relative to the base plate 3 or the work table 6.

The supporting C-frame 10 is traversed horizontally via suitable drives, for example a spindle drive or a linear drive, which interact with corresponding receptacles and links to the chassis 2 or the base plate 3 and the lower horizontal C-frame part 13.

The traverse of the supporting C-frame 10 along the two horizontal translational axes X, Y can be realized, for example, by the bottom C-frame part 13 being linked to an X-Y-coupling support 14, relative to which the bottom C-frame part 13 can be adjustably displaced along the second horizontal translational axis Y, the X-Y-coupling support 14 being adjustably displaceable along the first horizontal translational axis X.

In the preferred embodiment shown, the second horizontal translational axis Y runs in a horizontal plane which is arranged at a distance H below the horizontal plane in which the first horizontal translational axis X runs. This embodiment has proved to be especially advantageous with regard to simple practicability and nonetheless high rigidity, which is necessary for high-precision machining operations.

The top horizontal C-frame part 11 serves as an extension arm which carries an eccentric arm 15 at the front end thereof, and this eccentric arm 15 can foe arranged axially or laterally. The eccentric arm 15 in turn carries the tool holder 9 at the side. The tool holder 9 is thus arranged so as to be movable relative to the base plate 3 or the work table 6 by means of the supporting C-frame 10. The tool holder 9 can hold a tool, for example a drill 16 or an insertion shank for laboratory implants, and has an approximately vertical tool axis W. Furthermore, the tool holder 9 together with the eccentric arm 15 is pivotable relative to the top horizontal C-frame part 11 about a first horizontal pivot axis A, tine pivot axis A running parallel to the second horizontal translational axis Y. If the eccentric arm 15 is arranged eccentrically to the pivot axis A and also to the center axis of the top horizontal C-frame part 11, this ensures that the first horizontal pivot axis A and the tool axis W intersect at a common intersecting point O.

Furthermore, the tool holder 9 is mounted so as to be adjustably pivotable about a second horizontal pivot axis B, for example relative to the eccentric arm 15, wherein the pivot axes A, B lie in a common horizontal plane and form an angle of about 90° to one another, and the second horizontal pivot axis B is oriented parallel to the first horizontal translational axis X.

The second horizontal pivot axis B is preferably arranged perpendicularly to the second horizontal translational axis Y of the supporting C-frame 10, perpendicularly to the first horizontal pivot axis A, perpendicularly to the tool axis W and also perpendicularly to the main extension plane of the eccentric arm 15 and passes through said common intersecting point O. This can ensure that pivoting of the tool holder 9 leads to minimum lateral deflection.

Shown in the figures is a tool 17 which is inserted into the tool holder 9 and which consists of a drilling appliance with a drill 16. The drill point is located on said tool axis W. In order to now carry out the machining operation, the tool holder 9 is displaceably fixed to the eccentric arm 15, the displacement movement being effected along a third translational axis Z which runs along the tool axis W.

The three translational axes x, Y, Z are preferably arranged perpendicularly to one another in accordance with the three-dimensional Cartesian coordinates. The pivot angle is in each case about 45° about the pivot axes A and B and about 360° C. about the pivot axis C. The second horizontal translational axis Y advantageously intersects the third translational axis Z at an intersecting point S, in particular with respect to a vertical alignment of the third translational axis X.

Whereas all the axes A, B, C, X and Y shown can be secured via locking means (not shown), that is to say the parts adjustable along or about these axes can be secured relative to one another in a predetermined position, the tool holder 9 remains movable along the second translational axis W or the drilling axis Z in order to be able to carry out the machining operation.

Said axes can each be scanned with regard to their orientation or movement or position via transducers (not shown) in order to produce digitized data which, upon connection to a computer via an interface, enable these actual position data to be compared with predetermined set point data which can be worked out and transmitted by external software. In addition, the actual values can be transmitted to an indicating device (likewise not shown), where they can be compared with the set points in order to simplify the setting of the respective axes. The detected actual values which are used during the machining of the workpiece can be stored and archived in a tamper-proof manner in a black box (likewise not shown). As a result of the digitizing of the axes, an accuracy of up to 0.01 mm is possible, these accurate settings also being reproducible.

Finally, a retainer 18 for a milling arm (not shown) can also be seen in the drawings, which milling arm can serve to machine the workpiece using a milling cutter, the workpiece being arranged on the work table 6. A plurality of prosthetic abutments which belong to a common prosthesis can thus be parallelized, for example, on a jaw model clamped in place in the work holder.

A user who works with the machining apparatus 1 preferably sits on the left-hand side in FIGS. 1 and 4, where the operating elements 19 are located. In this case, the first horizontal translational axis X is oriented transversely to the direction of view of the user who is using the machining apparatus 1 and is observing the work table 6 in the process, and the second horizontal translational axis Y is oriented in the direction of view of the user who is using the machining apparatus 1 and is observing the work table 6 in the process. During the machining of the workpiece on the work table 6 by means of the machining apparatus 1, the user can assume a fixed position relative to the workpiece, since it is not moved during the machining, but rather all the movements required for the machining are effected by the supporting C-frame 10 and the pivoting of the tool holder 9 about the pivot axes A, B or the traverse of the tool holder 9 in the tool axis W (third translational axis Z). In addition, the user has in this case an optimum view and freedom of movement, because the supporting C-frame 10, i.e. the central vertical C-frame part 12, is arranged away from him and therefore a large area around the work table 6 is free from moving actuating or traversing devices, and in addition optimum machining precision is achieved as a result of the highly stable mechanical construction of the apparatus.

An implant drilling template is produced using the machining apparatus 1 according to the invention, for example in accordance with the following method steps:
Making a negative jaw impression (for example made of plaster or plastic) of the situation of the teeth of the jaw of a patient.
Taking a negative bite impression of the situation of the jaw by means of a bite template, which the patent bites on, a bite impression being formed in a deformable mass of the bite template. The bite template can at the same time serve as a radiographic template and as a zero positioning element, a “zero key”, for the subsequent alignment of the drilling template in the machining apparatus.
Producing a jaw model by means of the jaw impression.
Positioning the jaw model on the work table of the machining apparatus 1.
Modeling a radiographic template of at least part of the jaw model while inserting at least three reference marks (“landscapes”) at a predetermined mutual spacing and predetermined position with respect to the work table or jaw model.
Producing radiographs of the jaw, to be provided with an implant, of the patient using the radiographic template inserted into the mouth cavity.
Measuring and evaluating the radiographs by an electronic evaluating apparatus, in particular by a computer, and producing measurement data records.
Planning and determining the dental implant to be used and the position and orientation thereof (location, angle, depth) and the dental prosthesis or bridge to be used.
Calculating the position and orientation of the drill hole to be made in a drilling template from the position and orientation of the dental implant to be used.
Converting the calculated coordinates into the angular positions of the pivot axes A and B and of the displacement position of the translational axes X, Y, Z of the machining apparatus 1 for setting, with respect to the machining apparatus 1, the drilling position of the tool holder 9. The data with which the holes are drilled in the drilling template and if need be in the jaw model originate from virtual planning of the dental prosthesis. Here, a radiograph of the jaw is taken by means of a radiographic template, for which purpose the bite template itself can also be used (in this case the bite template has, at defined locations, position contrast elements, for example small metal pins, the position of which on the radiograph can be measured for determining the zero position), and suitable implants for the jaw and associated sleeves for the drilling template (diameter, length, etc.) and the positioning thereof are determined in the image by means of graphic planning software. The sleeves in the drilling template serve to drill a pilot hole having a defined depth in the jaw. The drilling direction and the drilling angles are predetermined in the process by the position of the sleeve in the drilling template. The data set determined with the planning software is then transmitted to the machining apparatus for setting the drill holes in the drilling template (and/or if need be the jaw model).
Modeling a drilling template for at least part of the jaw model or alternatively putting the radiographic template, which is used as drilling template, onto the jaw model. The drilling template is produced, for example, with the aid of a prosthesis which is already worn by the patient and which is to be supplemented, extended or stabilized or with the aid of the jaw model.
Setting the angular positions of the pivot axes A, B and the displacement position of the translational axes X, Y, Z in order to bring the tool holder 9 into the correct position relative to the drilling template.
Drilling a guide drill hole in the drilling template using a drilling tool inserted into the tool holder 9, the drilling template being put onto the jaw model.

To drill the holes in the drilling template, the drilling template together with the jaw model is clamped in place in the work holder of the machining apparatus. To find and set the zero position of the drilling template in the machining apparatus as an initial position for the machining with the machining apparatus, the axes of the machining apparatus are moved into a zero position, and, in this position of the machining apparatus, the bite template is inserted into a corresponding template holder positioning plate, which is fitted in the tool holder, into the machining apparatus. For alignment relative to the template holder positioning plate, the bite template has positioning elements, for example positioning pins, positioning holes or projections, which interact with corresponding positioning elements on the template holder positioning plate in a positive-locking manner. As a result, the bite template clamped in place in or inserted into the tool holder is aligned in the zero position of the machining apparatus.

The drilling template with the jaw model is then aligned manually relative to the machining apparatus with the aid of the bite template by the drilling template together with the jaw model being moved up into contact with the bite template by moving the work holder. The work holder is fixed in this zero position. The jaw model and the drilling template are thus positioned in the zero position in the machining apparatus by means of the bite template.

After that, the bite template and the associated template holder positioning plate are removed from the tool holder said the drilling device is clamped in place in the tool holder. The machining apparatus then automatically drills the drill holes in the drilling template or, in embodiments in which the drill holes are also to be set in the jaw model, through the drilling template into the jaw model. In this case, it is of course possible to separately drill the drilling template and the jaw, which may be expedient for example if different drill diameters are used.

This can then be followed, by the attachment of the dental implant and of the dental prosthesis, as follows:
After the drilling of the holes in the drilling template, the sleeves are screwed into the drilling template. However, the final depth setting of the sleeves in the drilling template is not effected until the drilling template is inserted into the mouth of the patient.
Inserting the drilling template into the mouth cavity of the patient.
Positioning the sleeves with regard to the depth setting thereof in the drilling template. In some embodiments, they are, for example, brought into contact with the gum, the raucous membrane or the bone.
Drilling the implant hole in the jaw through the guide drill hole in the drilling template or the sleeve in the drilling template to the predetermined drilling depth.
Removing the drilling template from the mouth cavity.
Inserting the dental implant into the implant hole.
Attaching the dental prosthesis to the dental implant.

In more complex cases, if the dental prosthesis is first modeled on the jaw model before it is inserted into the mouth cavity, the above procedure may be as follows:
Drilling the guide drill hole not only in the drilling template using a drilling tool inserted into the tool holder 9, but also drilling an implant hole through the drilling template into the jaw model, onto which the drilling template is put, to the predetermined drilling depth.
Removing the drilling template from the jaw model.
Manually or mechanically inserting the dental implant into the implant hole in the jaw model. In the process, no high-grade jaw dental implant is used as a rule, but rather a less expensive replacement, which is also referred to as implant analog, technician implant or laboratory implant. As a rule, a laboratory implant for a jaw model differs from a jaw dental implant in the material (e.g. aluminum instead of titanium) and in the surface finishing.
If need be, inserting a prosthetic post into the laboratory implant.
Modeling the dental prosthesis on the laboratory implant in the jaw model.
Removing the dental prosthesis from the jaw model.
Inserting the drilling template into the mouth cavity of the patient.
Drilling the implant hole in the jaw through the guide drill hole in the drilling template to the predetermined drilling depth.
Removing the drilling template from the mouth cavity.
Inserting the dental implant into the implant hole in the jaw.
If need be, inserting a prosthetic post into the dental implant.
Attaching the dental prosthesis to the dental implant or to the prosthetic post in the jaw.

This sequence assumes that the dental implants or laboratory implants can be inserted manually into the holes in the jaw model in a sufficiently precise manner. In the process, however, considerable inaccuracies occur with regard to the position, orientation and depth of the implants inserted into the jaw model, the result of which is that, subsequently, the dental implant does not fit accurately into the jaw or the dental prosthesis does not fit accurately onto the dental implant in the jaw. In this case, rework is necessary when placing the dental implant or the dental prosthesis, which involves complications and loss of quality.

This complication arises not only with regard to the insertion depth of the dental or laboratory implants, which is to be adhered to in a defined manner, but also if, in the case of a larger dental prosthesis, a plurality of dental or laboratory implants which belong together are jointly placed, for example up to 8 pieces or more, or if special dental or laboratory implants are used, the installation orientation of which is not arbitrary, but rather with which a certain orientation in the direction of rotation about their longitudinal axis has to be maintained.

Such non-rotationally symmetrical dental or laboratory implants consist, for example, of a bone part which is inserted into the jawbone and of an attachment part, which is also referred to as a prosthetic part, attachment, post, post, pillar or crown stump and is anchored in the bone part. The prosthetic parts can be, for example, axially symmetrical; for example they can have a triangular, square, pentagonal or hexagonal cross section. A feature that they have in common is that they cannot he inserted in any desired direction of rotation about their axial longitudinal axis, but rather have to maintain a certain orientation. This orientation is mostly such that an area of the prosthetic part, i.e., e.g., an edge of a triangular or polygonal cross section, must point exactly forward with respect to the mouth cavity.

As a rule, this orientation can be seen on the prosthetic parts and the associated bone parts by a marking, and, during the insertion of the bone parts and prosthetic parts, not by the insertion depth but also this orientation must be exactly maintained.

Here, the machining apparatus 1 provides an advantageous means for realizing the accuracy requirements with regard to the demand for inserting the dental or laboratory implants into the implant holes in the jaw model in a highly precise manner. A machining apparatus 1 according to the invention for dental technicians and dentists, in particular for producing a drilling template for dental implants, can be used not only for the drilling of drilling templates but also for inserting laboratory implants into a jaw model. The sequence described above is in this case modified as follows:
Drilling the guide drill hole not only in the drilling template using a drilling tool inserted into the tool holder 9, but also drilling an implant hole through the drilling template into the jaw model, onto which the drilling template is put, to the predetermined drilling depth.
Removing the drilling template from the jaw model.
Inserting the laboratory implant or the bone part of a laboratory implant into a placement tool inserted into the tool holder 9, if need be with the drilling tool being exchanged for the placement tool.
Mechanically inserting the laboratory implant or the “bone part” of a laboratory implant into the implant hole in the jaw model by means of the machining apparatus 1 using the positioning data stored for this implant hole (by moving the placement tool along the tool axis W or vertical translational axis Z).
If need be, inserting (manually or mechanically) a prosthetic part into the laboratory implant.
If need be, leveling/straightening/aligning the alignment surfaces of one or more laboratory implants, for example by grinding or milling, preferably with the orientation of a flat alignment surface of the laboratory implant or prosthetic part in a direction pointing directly out of the mouth cavity.

Modeling the dental prosthesis on the laboratory implant in the jaw model or on the prosthetic part in the bone part of the jaw model.

Removing the dental prosthesis from the jaw model.
Inserting the drilling template into the mouth cavity of the patient.
Drilling the implant hole (or a pilot hole) in the jaw through the guide drill hole in the drilling template to the predetermined drilling depth.
Removing the drilling template from the mouth cavity.
Inserting the dental implant or the bone part into the implant hole in the jaw.
If need be, inserting a prosthetic part into the bone part in the jaw.
Attaching the dental prosthesis to the dental implant in the jaw or to the prosthetic part in the bone part in the jaw.

This sequence ensures that the dental or laboratory implants, with regard to their positioning, including the depth and/or the alignment about the longitudinal axis, are inserted precisely into the holes in the jaw model and in the jaw.

A correspondingly configured machining apparatus 1 according to the invention accordingly has the feature that the desired positioning data used for automatically drilling a drill hole, in particular in a jaw model, by means of a drilling tool cart be stored and can be retrieved for automatically placing a dental or laboratory implant in the drill hole by means of a placement tool using the stored desired positioning data, and the machining apparatus is designed for automatically placing a dental or laboratory implant in a drill hole automatically drilled with the machining apparatus, using a placement tool and the stored desired positioning data.

A corresponding method tor automatically placing a dental implant or laboratory implant in a drill hole in a jaw model comprises the following steps:
automatically drilling a drill hole in the jaw model using a drilling apparatus which has motor-operated actuating drives which are designed such that they can be activated for automatically setting defined positions with the aid of digital desired positioning data, in particular using a machining apparatus 1 according to the invention, by means of a drilling tool with the aid of stored desired positioning data, and
automatically placing a dental or laboratory implant in the drill hole by means of at placement tool with the machining apparatus 1, using the stored desired positioning data.

In a corresponding manner, the machining apparatus 1 according to the invention provides an advantageous means for realizing the accuracy requirements with regard to the demand for inserting the drilling sleeves into the drill holes in at drilling template in a highly precise manner. The sequence described above is in this case modified as follows:
Drilling the guide drill hole in the drilling template using a drilling tool inserted into the tool holder 9.
Inserting the drilling sleeve for drilling an implant hole of a dental implant into a placement tool inserted into the tool holder 9, if need be with the drilling tool being exchanged for the placement tool.
Mechanically inserting she drilling sleeve into the guide drill hole by means of the machining apparatus 1 using the positioning data stored for this guide drill hole (by moving the placement tool along the tool axis W or vertical translational direction Z).
Inserting the drilling template into the mouth cavity of the patient.
Drilling the implant hole in the jaw through the drilling sleeve in the guide drill hole in the drilling template to the predetermined drilling depth.
Removing the drilling template from the mouth cavity.
Inserting the dental implant or the bone part into the implant hole in the jaw.
If need be, inserting a prosthetic part into the bone part in the jaw.
Attaching the dental prosthesis to the dental implant in the jaw or to the prosthetic part in the bone part in the jaw.

This sequence ensures that the drilling sleeves, with regard to their positioning, including the depth and/or the alignment about the longitudinal axis, are inserted precisely into the guide drill holes in the drilling template.

A corresponding machining apparatus 1 according to the invention accordingly has the feature tin at the desired positioning data used for automatically drilling a drill hole, in particular in a drilling template for a dental or laboratory implant, by means of a drilling tool cam be stored and can be retrieved for automatically placing a drilling sleeve in the drill hole by means of a placement tool using the stored desired positioning data, and the machining apparatus 1 is designed for automatically placing a drilling sleeve in a drill hole automatically drilled with the machining apparatus 1, using a placement tool and the stored desired positioning data.

A corresponding method for automatically placing a drill sleeve in a drilling template for a dental implant comprises the following steps:
Automatically drilling a drill hole in the drilling template using a drilling apparatus which has motor-operated actuating drives which are designed such that they can be activated for automatically setting defined positions with the aid of digital desired positioning data, in particular using a machining apparatus 1 according to the invention, by means of a drilling tool with the aid of stored desired positioning data, and
automatically placing a drilling sleeve in the drill hole by means of a placement tool with the machining apparatus, using the stored desired positioning data.

In the invention, the position parameters and angular position parameters of the drill holes or of the dental implants, prosthetic parts or drilling sleeves are optimally set separately from one another. Whereas the tool 17 can be traversed three-dimensionally in its position by means of the three translational area X, Y and Z, the direction of the tool 17 is produced solely by tilting the retainer for the tool 17 about the pivot axes A and B. In this case, the mechanical construction of the machining apparatus 1 is such that high mechanical rigidity with at she same time optimum ease of operation and automation are provided for. The invention therefore offers the advantage of being able to match the essential adjusting means to one another in such a way that the associated axes coincide in the tool 17 and thus the adjustment of an axis does not automatically lead to a change in the machining region as a result of too large a pivoting range, as with eccentrically arranged tool axes. In summary, the invention offers the advantage of a machine apparatus 1 which makes possible ergonomically optimum, reproducible and highly accurate work.

### LIST OF DESIGNATIONS

1 Machining apparatus

### 2 Chassis

3 Base plate

### 4 Foot

5
6 Work table

### 7 Actuator

8 Traversing device
9 Tool holder

### 10 Supporting C-frame

11 Top horizontal C-frame part
12 Central vertical C-frame part
13 Bottom horizontal C-frame part
14 X-Y-coupling support

### 15 Eccentric arm

### 16 Drill

### 17 Tool

18 Milling arm retainer
19 Operating element
A First horizontal pivot axis for tool
B Second horizontal pivot axis for tool
C Vertical pivot axis for tool

### H Distance

O Common intersecting point of A, B and W
S Intersecting point of Y and Z
W Approximately vertical tool axis
X First horizontal translational axis for tool (transversely to the extension arm)
Y Second horizontal translational axis for tool (along extension arm)
Z Third approximately vertical translational axis for tool

1. A machining apparatus for dental technicians and dentists, in particular for producing a drilling template for dental implants, comprising
a fixed, stationary chassis having a fixed, stationary base plate which at least indirectly carries a work table for accommodating a workpiece,
a tool holder movably arranged relative to the base plate for a tool, such as, in particular, a drill, having an approximately vertical tool axis, wherein the tool holder is adjustably pivotable relative to the base plate about a first horizontal pivot axis and a second horizontal pivot axis, wherein the pivot axes lie in a common horizontal plane and form an angle of about 90° to one another,
and a traversing device for traversing the tool holder relative to the work table, wherein the traversing device is linked to the chassis or the base plate, carries the tool holder and has two translational axes, along which the tool holder can be adjustably traversed by means of the traversing device,
wherein the first translational axis and the second translational axis are oriented in a horizontal direction, and the first translational axis and the second translational axis lie in a common horizontal plane and form an angle of about 90° to one another, and
the tool holder can be traversed along a third translational axis, which is identical to the tool axis, relative to the work table,
wherein
the traversing device is designed as a traversable, inherently rigid supporting C-frame which comprises a top horizontal C-frame part, a central vertical C-frame part and a bottom horizontal C-frame part,
the first horizontal translational axis is oriented transversely to the supporting C-frame and parallel to the second horizontal pivot axis,
the second horizontal translational axis is oriented in the direction of the top C-frame part and bottom C-frame part and parallel to the first horizontal pivot axis,
the bottom C-frame part can be adjustably traversed along the first horizontal translational axis relative to the base plate, and
the bottom C-frame part can be adjustably traversed along the second horizontal translational axis relative to the base plate.

2. The machining apparatus as claimed in claim 1, wherein the second horizontal translational axis runs in a horizontal plane which is arranged at a distance below the horizontal plane in which the first horizontal translational axis runs.

3. The machining apparatus as claimed in claim 1, wherein the first horizontal translational axis is oriented transversely to the direction of view of a viewer who is using the machining apparatus and is observing the work table in the process.

4. The machining apparatus as claimed in claim 1, wherein the second horizontal translational axis is oriented in the direction of view of a viewer who is using the machining apparatus and is observing the work table in the process.

5. The machining apparatus as claimed in claim 1, wherein the bottom C-frame part is linked to an X-Y-coupling support relative to which the bottom C-frame part can be adjustably displaced along the second horizontal translational axis, wherein the X-Y-coupling support can be adjustably displaced along the first horizontal translational axis.

6. The machining apparatus as claimed in claim 1, wherein at least two, preferably all three axes of the two horizontal pivot axes and the tool axis intersect at a common intersecting point.

7. The machining apparatus as claimed in claim 1, wherein the second horizontal translational axis intersects the third translational axis at an intersecting point, in particular with respect to a vertical alignment of the third translational axis (Z).

8. The machining apparatus as claimed in claim 6, wherein the intersecting point does not coincide with the common intersecting point.

9. The machining apparatus as claimed in claim 6, wherein the intersecting point lies below the common intersecting point.

10. The machining apparatus as claimed in claim 6, wherein the intersecting point lies below the workpiece.

11. The machining apparatus as claimed in claim 6, wherein the intersecting point lies below the horizontal plane in which the first horizontal translational axis runs.

12. The machining apparatus as claimed in claim 6, wherein the intersecting point lies within the base plate.

13. The machining apparatus as claimed in claim 1, wherein the tool holder is attached to the top C-frame part in a position which is stationary relative to the top C-frame part.

14. The machining apparatus as claimed in claim 1, wherein the three translational axes are arranged perpendicularly to one another in accordance with the three-dimensional Cartesian coordinates.

15. The machining apparatus as claimed in claim 1, wherein the work table or a work holder of the work table for the workpiece is designed in such a way that the workpiece can be pivoted about a vertical pivot axis extending perpendicularly to the base plate.

16. The machining apparatus as claimed in claim 1, wherein the pivot axes and/or translational axes have scanning means, by means of which digitized actual position data concerning the pivot and/or translational position can be produced.

17. The machining apparatus as claimed in claim 1, wherein it has in each case a motor-operated actuating drive for adjustably pivoting the tool holder about the first pivot axis and the second pivot axis.

18. The machining apparatus as claimed in claim 1, wherein it has in each case a motor-operated actuating drive for adjustably traversing the supporting C-frame along the first horizontal translational axis and the second horizontal translational axis.

19. The machining apparatus as claimed in claim 1, wherein it has an actuating drive for adjustably traversing the tool along the tool axis and/or for adjustably traversing the tool holder along the third translational axis.

20. The machining apparatus as claimed in claim 16, wherein the motor-operated actuating drives are designed such that they can be activated for automatically setting defined positions with the aid of digital desired positioning data.

21. The machining apparatus as claimed in claim 1, wherein the desired positioning data used for automatically drilling a drill hole, in particular in a jaw model, by means of a drilling tool can be stored and can be retrieved for automatically placing a dental or laboratory implant in the drill hole by means of a placement tool using the stored desired positioning data, and the machining apparatus is designed for automatically placing a dental or laboratory implant in a drill hole automatically drilled with the machining apparatus, using a placement tool and the stored desired positioning data.

22. The machining apparatus as claimed in claim 1, wherein the desired positioning data used for automatically drilling a drill hole, in particular in a drilling template for a dental or laboratory implant, by means of a drilling tool can be stored and can be retrieved for automatically placing a drilling sleeve in the drill hole by means of a placement tool using the stored desired positioning data, and the machining apparatus is designed for automatically placing a drilling sleeve in a drill hole automatically drilled with the machining apparatus, using a placement tool and the stored desired positioning data.

23. Method for automatically placing a dental implant or laboratory implant in a drill hole in a jaw model, comprising the following steps:
automatically drilling a drill hole in the jaw model using a drilling apparatus which has motor-operated actuating drives which are designed such that they can be activated for automatically setting defined positions with the aid of digital desired positioning data, in particular using a machining apparatus as claimed in claim 1, by means of a drilling tool with the aid of stored desired positioning data, and automatically placing a dental or laboratory implant in the drill hole by means of a placement tool with the machining apparatus, using the stored desired positioning data.

24. A method for automatically placing a drill sleeve in a drilling template for a dental implant, comprising the following steps:
automatically drilling a drill hole in the drilling template using a drilling apparatus which has motor-operated actuating drives which are designed such that they can be activated for automatically setting defined positions with the aid of digital desired positioning data, in particular using a machining apparatus as claimed in claim 1, by means of a drilling tool with the aid of stored desired positioning data, and
automatically placing a drilling sleeve in the drill hole by means of a placement tool with the machining apparatus, using the stored desired positioning data.
